(19) United States
(12) Patent Application Publication
(10) Pub. No.: US 2012/0295542 A1
(43) Pub. Date: Nov. 22, 2012

(54) SYSTEM FOR CREATING WEB BASED APPLICATIONS LINKED TO RFID TAGS

(76) Inventor: Edvin Telemi, La Crescenta, CA (US)

(21) Appl. No.: 13/473,312

(22) Filed: May 16, 2012

Related U.S. Application Data
(60) Provisional application No. 61/487,044, filed on May 17, 2011.

(51) Int. Cl. H04B 5/00

(52) U.S. Cl. 455/41.1

(57) ABSTRACT

A system for creating simple and efficient web based applications and using radio-frequency identification (RFID) tags to link the applications to products, fliers, or any other objects and activated by a near field communications (NFC) enabled mobile device using an application maker, a web host server and computer instructions for distributing applications and advertisements created by the application maker when a user accesses an RFID tag associated with the application.

### CROSS-REFERENCE TO RELATED APPLICATIONS

The present Application is a non-provisional patent application and claims the benefit of U.S. Provisional Patent Application No. 61/487,044, titled “System For Creating Web Based Applications Linked To RFID Tags,” filed May 17, 2011; the contents of which are incorporated in this disclosure by reference in their entirety.

### FIELD

The invention pertains to the field of advertising and more specifically to a system for creating simple and efficient web based applications and using radio-frequency identification (RFID) tags to link the applications to products, fliers, or any other objects and activated by a near field communications (NFC) enabled mobile device.

### BACKGROUND

There are numerous advertisements systems using barcodes and RFID tags. Among these are the Cue-Cat system and the Google® Nexus S device. Disadvantageously, the Cue-Cat system required a user to connect the Cue-Cat device to a computer and scan bar codes from advertisements to go to a web site for more information or special offers. This required the user to read and scan the information while at the keyboard, limiting the options for advertisers and inconveniencing the user. The Google® Nexus S has the same capabilities as the Cue-Cat to launch a web site in a phone's web browser by scanning a RFID tag containing the URL. This method does not have any other function other than simply reading the URL from the RFID tag and using the built in web browser to access the site. Because the screen size on these devices is limited, the amount of information is also limited and may not be viewed by the user at all.

Therefore, there exists a need for a system for creating simple and efficient web based applications and using radio-frequency identification (RFID) tags to link the applications to products, fliers, or any other objects and activated by a near field communications (NFC) enabled mobile device that is not associated with these disadvantages.

### BRIEF DESCRIPTION OF THE DRAWINGS

These and other features, aspects and advantages of the present invention will become better understood with regard to the following description, appended claims, and accompanying figures where:

FIG. 1 is a diagram of a system for creating simple and efficient web based applications and using radio-frequency identification (RFID) tags to link the applications to products, fliers, or any other objects and activated by a near field communications (NFC) enabled mobile device;

FIG. 2 is a flow chart of how to use the system of FIG. 1; and

FIG. 3 is a diagram of an exemplar restaurant application of the system of FIG. 1.

### SUMMARY

In one embodiment there is provided a system for creating simple and efficient web based applications and using radio-frequency identification (RFID) tags to link the applications to products, fliers, or any other objects and activated by a near field communications (NFC) enabled mobile device, the system comprising an application maker, a web host server and computer instructions for distributing applications and advertisements created by the application maker when a user accesses an RFID tag associated with the application. The application maker comprises templates and an application program interface for creating applications and advertisements.

A user accesses the RFID tag associated with the application using a tablet, a smart phone or a personal computer. The personal computer accesses the applications using a web interface hosted by the web host server.

In another embodiment there is provided a method for using the system comprising the steps of: a)creating a user account; b) downloading an application onto a compatible device to login to the user account; c) synchronizing content selected by the user between the device and the account; d) scanning an RFID tag associated with an application; e) downloading instructions operable on the device that can launch a an application associated with the RFID tag; and f) interacting with the application on the device. The account comprises a comprehensive profile to provide a richer and more personalized experience to the user. Interacting with the application on the device also comprises displaying advertisements to the user. The applications can be stored in a storage on the device for later use or distribution to other users using social networks.

In another embodiment there is provided a system for creating simple and efficient web based applications and using radio-frequency identification (RFID) tags to link the applications to products, fliers, or any other objects and activated by a near field communications (NFC) enabled mobile device comprising: a website hub repository for storing applications associated with a user; code operable on the website comprising instructions for: 1) an update storage for providing updates to a device capable of performing the instructions; 2) an application storage for storing applications created by a user; 3) an interface for creating applications; and 4) a dashboard for tracking applications selected by the user and applications created by the user. The code further comprises computer instructions for analyzing a users' tapping history, constructing a comprehensive, user specific interests portfolio and executing algorithms that can construct a virtual personality of the user based on a frequency of metatags associated with each application stored in the application storage and instructions for distributing advertisements to the user based on the interests portfolio, the virtual personality or both the interest portfolio and the virtual personality.

The system further comprises templates for developing applications and an application program interface for developing applications.

The RFID tags comprise: a unique code representing a specific location; a unique application operably connected to the unique code; and instructions operable on the device to launch the unique application associated with the unique code. The unique application can be launched in a web browser. Also, the unique code can be encoded into a QR code.

The system further comprises a notification module. The dashboard module comprises organizational tools for the user selected from the group consisting of a calendar, expiring offers, event invites and time sensitive flyers.

### DETAILED DESCRIPTION

The present invention solves these problems. The core WebiTap™ experience will take place in the real world and revolutionize the information uptake from the physical world by bringing the tools and innovations of computing power of the web on to the user's palm. Because RFID tags are cheap to produce, manufacturers can implement the tags into their products in a cost effective manner and incorporate extra information linking the product to a TagApp™. Additionally, printing shops can print RFID tags for individuals or lower quantity runs. This will enable objects encountered on a daily basis to carry the RFID tag and enable a user to tap on these objects and gain access to a information and/or specific application associated with the object instantly.

For example, if the user would like to see if a memory card that they are about to purchase is compatible with a specific brand of camera. The user can tap on the memory card packaging, enter the camera model into the TagApp™, and find out. Also for example, if the user would like to see a trailer of a movie or video game displayed on a shelf, the user only needs to tap on the package. Trailers, reviews, and user feedback are then made available with a single tap. Or in another example, the user can place an order by simply tapping over a pizza flyer found in the mail, and the TagApp™ can send the user's information to the restaurant with one click. Like that shirt? See what other clothes go with it, and what colors match best with the customized interactive TagApp™ that launches when the user taps the shirt's tag. WebiTap™ will allow the user to enjoy media rich brochures, event flyers that automatically synchronize with your calendar, and coupons that alert you when they are about to expire.

According to one embodiment of the present invention, there is provided a system for advertisements and custom conversion that a competition that provides cash incentives to competitors. The system will now be disclosed in detail.

All dimensions specified in this disclosure are by way of example only and are not intended to be limiting. Further, the proportions shown in these Figures are not necessarily to scale. As will be understood by those with skill in the art with reference to this disclosure, the actual dimensions of any device or part of a device disclosed in this disclosure will be determined by its intended use.

As used in this disclosure, except where the context requires otherwise, the term “comprise” and variations of the term, such as “comprising”, “comprises” and “comprised” are not intended to exclude other additives, components, integers or steps.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments can be practiced without these specific detail. Well-known circuits, structures and techniques may not be shown in detail in order not to obscure the embodiments. For example, circuits can be shown in block diagrams in order not to obscure the embodiments in unnecessary detail.

Also, it is noted that the embodiments can be described as a process that is depicted as a flowchart, a flow diagram, a structure diagram, or a block diagram. Although a flowchart can describe the operations as a sequential process, many of the operations can be performed in parallel or concurrently. In addition, the order of the operations can be rearranged. A process is terminated when its operations are completed. A process can correspond to a method, a function, a procedure, a subroutine, a subprogram, etc. When a process corresponds to a function, its termination corresponds to a return of the function to the calling function or the main function.

Moreover, a storage can represent one or more devices for storing data, including read-only memory (ROM), random access memory (RAM), magnetic disk storage mediums, optical storage mediums, flash memory devices and/or other machine readable mediums for storing information.

Furthermore, embodiments can be implemented by hardware, software, firmware, middleware, microcode, or a combination thereof. When implemented in software, firmware, middleware or microcode, the program code or code segments to perform the necessary tasks can be stored in a machine-readable medium such as a storage medium or other storage(s). A processor can perform the necessary tasks. A code segment can represent a procedure, a function, a subprogram, a program, a routine, a subroutine, a module, a software package, a class, or a combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted through a suitable means including memory sharing, message passing, token passing, network transmission, etc.

In the following description, certain terminology is used to describe certain features of one or more embodiments of the invention.

The term “machine readable medium” includes, but is not limited to portable or fixed storage devices, optical storage devices, wireless channels and various other mediums capable of storing, containing or carrying instruction(s) and/or data.

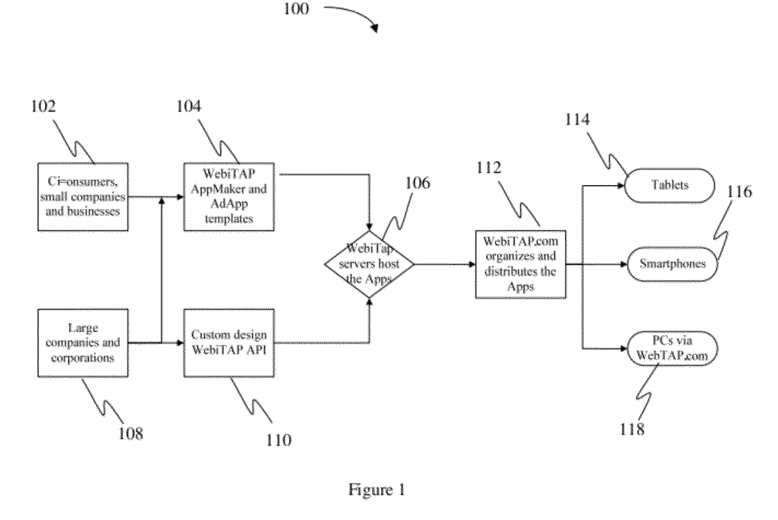

Referring now to FIG. 1, there is shown a system 100 for creating simple and efficient web based applications and using radio-frequency identification (RFID) tags to link the applications to products, fliers, or any other objects and activated by a near field communications (NFC) enabled mobile device, according to one embodiment. As can be seen, the system 100 allows consumers and regular users 102 or large companies and corporations 108 to use an application maker 104 comprising templates for applications and advertisements. Optionally, the large corporations and companies 108 can create a custom-designed application 110 using an application program interface (API). In either case, once the application is created using either the templates 104 or a custom-designed 110 they are uploaded to a host server 106 and made available to users. The server 106 organizes and distributes the applications 112 whenever a user scans an RFID tag associated with the application 112 using a tablet 114, a smart phone 116 or a personal computer 118. The personal computer 118, can access various applications by visiting a website hosted by the server 106.

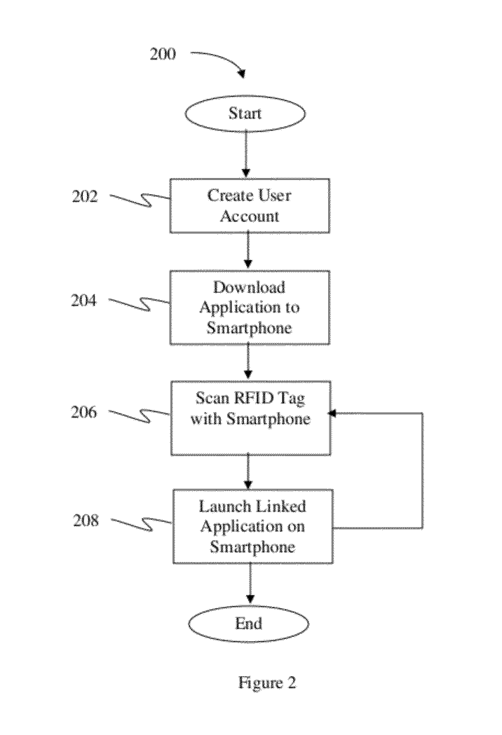

Referring now to FIG. 2, there is a flow chart diagram 200 of how to use the system of FIG. 1 according to one embodiment of the present invention. First, a user creates an account 202 for inputting basic information such as name and address. The account will allow the user to create a more comprehensive profile that will provide for a richer and more personalized experience. Then, the user will be prompted to download a WebiTap™ mobile application 204 on to a compatible smart phone and log in to the user's account. Next, the user's content will be continuously synchronized between the phone and the website. Then, the user can scan 206 any WebiTap™ RFID tag. Next instructions operable on the phone will launch 208 a TagApp™ and the user view the corresponding application on their phone. Depending on the application, the user can simply interact with its functions and obtain more information, such as a brochure application, or enter preferences to receive personalized services, such as an insurance quote application. The user will then be able to save the applications for future use or optionally share the application with other users. The user will also be able to create their own TagApps™, receive recommended TagApps™, updates based on tagging history and specified interests, and connect and share TagApps™ with other users from different social networks including LinkedIn®, Facebook®, and Twitter®.

In one embodiment, the WebiTap™ website will be a central hub for all of the user's TagApps™. The website will have five major sections: Updates, MyTAG™, AppMaker™, and TagDashboard™.

The WebiTap™ website can provide users with updates for the relevant TagApps™ based on the user's tapping history. The WebiTap™ website comprises computer instructions that can analyze the users' tapping history and construct a comprehensive, user specific interests portfolio. Further, the WebiTap™ website also comprises instructions for executing algorithms that can construct a virtual personality of the user based on the frequency of “TagWords” associated with each TagApp™. The more things and places a user taps, the more accurate the interests portfolio. The WebiTap™ website can provide the user with advertising oriented TagApps™, or more specifically, AdApps™ that are tailored to the user's interests based on the user's interest portfolio. The user will not view AdApps™ as irrelevant or annoying advertisements, but rather, will appreciate them as resources that provide updated information on new products, coupons for products or services the user has expressed an interest in or that the user might find helpful. Furthermore, AdApps™ will not be a typical advertisement because each AdApp can comprise instructions for multimedia functionality that can encourage the user to subscribe or save the TagApp™. These features of the WebiTap™ system provide for a very powerful advertising machine that is both useful to the user and very effective for the advertiser. Instead of attacking the user's subconscious like most advertisements, the WebiTap™ updates are a dynamic infrastructure that will appeal to the user's conscious mind. The user will also have the ability to restrict what information is used to create their interests portfolio by changing settings on the WebiTap™ site. The goal is to have the advertisement fit in naturally with the WebiTap™ experience, and be so unique to the user's interests that the user will appreciate receiving updates from the WebiTap™ site. User's will browse through the advertisements willingly rather than seeing them as an intrusion of privacy and thus ignoring them. The following scenarios are exemplars of the system:

### Scenario 1:

The WebiTap™ system has executed computer code to analyze over 200 TagApps™ that John, a user, has tapped or used and has identified certain trends that display John's interests. John has tapped many books, most of them non-fiction, with about 30% of them on World War II aircraft. He also has TagApps™ for a few WW II movies and one for a video game. There is going to be a World War II exhibit in San Diego next month. Based on the information he has provided in his portfolio, the code executed at the WebiTap™ website has determined that John would be very interested in this exhibition, which is only 20 miles from his home, and brings up the AdApp™ in John's update section. The AdApp™ features videos from previous exhibitions, interviews, and descriptions of some of the items presented including the aircrafts that are going to be there. John likes the AdApp™ and decides to save it so he can read up on the details later. While waiting at a bus stop, John pulls up the AdApp™ on his phone, since its synced with his online account, and reads a couple of articles, watches a video or two, and sees that his friend from Facebook® is also going to this event (all of this is done within the AdApp™). John decides to spend the $100 and buy the ticket through AdApp™ which will be charged to his credit card or Paypal® account with one simple click. The date and location of the place are synced with his Google calendar and the ticket is now saved onto his phone.

### Scenario 2:

Using the same method, the WebiTap™ system has determined that Katie eats fast food regularly and really likes burgers. WebiTap™ brings up Burger King®'s AdApp™ in her Updates section. Katie clicks on it to find out that Burger King® is offering a free drink with a purchase of a burger. The AdApp™ also has a cool interactive Burger King® menu that incorporates a calorie counter that helps you plan your meals. Katie loves the AdApp™ and chooses to save it. However, to activate the coupon for the free drink, she has to share the AdApp™ with her friends on Facebook® and Twitter®. Katie doesn't mind, thinking many of her friends would appreciate the offer. With this method, Burger King® not only made a potential customer out of Katie, but, through Katie, Burger King® started a chain reaction that could potentially get the AdApp™ on to the phones of millions of others who also use social networking sites.

Using the WebiTap™ system, marketing teams can develop creative AdApps™ that best suits the advertising needs of a company. The AdApps™ can provide a more engaging and exciting advertising environment that users will really appreciate. The examples above showcase some of the powerful methods that companies can use to reach out to customers. For small business and individuals, the WebiTap™ system can provide AdApp™ templates that can be filled out and published easily without requiring any programming knowledge. Companies can also compile detailed statistics of the users of their AdApps™, such as demographic information or periods of peak tapping traffic, that can aid the company in producing better products and AdApps™.

The MyTAGs™ section of the website is user oriented without any interruption from the updates section or other advertisements. MyTAGs™ focuses on organizing saved TagApps™. WebiTap™ system will organize the TagApps™ into simplified specific categories based on a preset category related to the function of the TagApps™, allowing the user to quickly search and find TagApps™. For example, the TagApp™ of a brochure will be saved under a brochures tab, while flyers and business cards go to their respective categories. Optionally, users can create other categories. For example, a user created “school” tab, can hold all TagApps™ that are school and class oriented. Users can view and interact with the TagApps™ on the website similarly to the Smartphone TagApp™. The user can also save, delete, or share TagApps™ with friends using email or social media websites. Any changes to the MyTAGs™ section will be simultaneously synced with the WebiTap™ application on the user's Smartphone.

TagApps™ or linkable applications can be created and published using WebiTap™'s easy-to-use online AppMaker™. The application creation process can be as simple as filling in the required information on a template, or dragging and dropping pre-coded features to create a more personalized application. The average user will need no developing or programming knowledge as basic computer skills will suffice, allowing anyone to create an AdApp™ or a TagApp™. The WebiTap™ system comprises executable code that will charge the user a small amount for more intricate templates, but will many free templates. More savvy users or larger companies and corporations can create more complex and custom TagApps™ using the same web based development environment. User's with some programming knowledge can create templates and publish them on the site for sale, sharing a small percentage of revenue with owners of the WebiTap™ system.

Once the TagApps™ is completed, it is published and categorized by assigning a unique WebiTap™ system code that links the TagApp™ to an specific RFID tag code. The user can then order the RFID tags that contain the code directly from the website or purchase WebiTap™ tags from retailers and use their mobile device to link TagApp™ to the tag. The RFID tags will not contain anything other than the code and optionally pricing information. The WebiTap™ application on the device is capable of decoding the information stored on the RFID tag. The RFID tags used for product packaging, flyers or posters can be stickers that comprise a WebiTap™ logo to alert potential users that they can use their Smartphone's with the item. The advertiser would simply place the sticker on a flyer before handing it out. For larger orders, professionally imprinted RFID chips can be ordered by contract with the owners of the WebiTap™ system.

TagApps™ can be stored on WebiTap™ servers and the TagApps™ can be pushed to mobile phones, tablets, and personal computers requested by the user or when an RFID tag is tapped by a user. The user does not save TagApps™ on their Smartphone or computer. The Smartphone can use any type of available internet connection to access the WebiTap™'s system. The TagApps™ will have a multitude of different functionalities that are to be determined by the producers for their specific purpose.

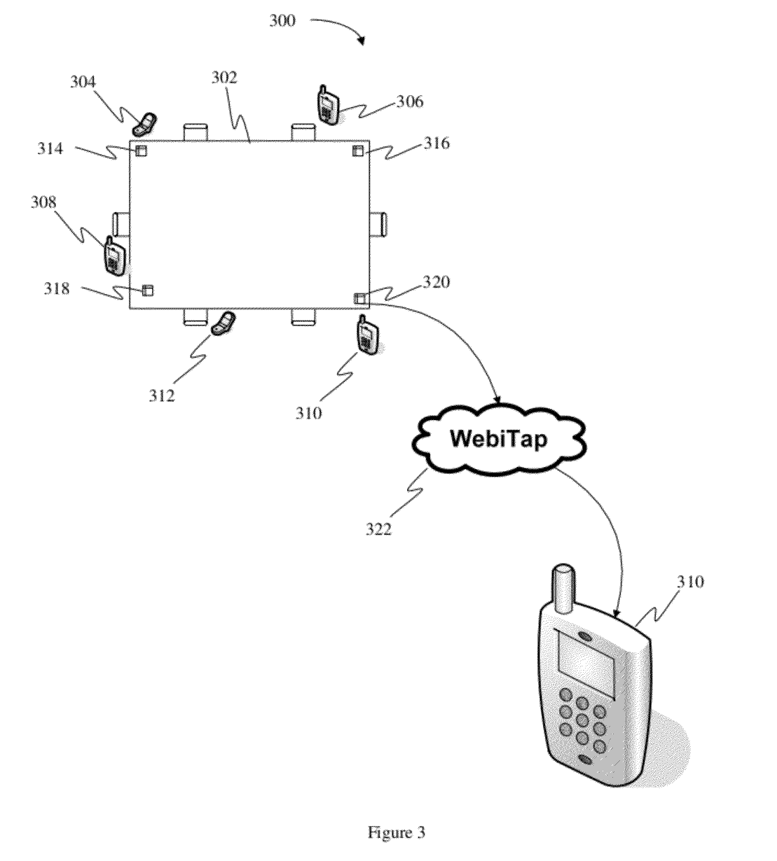

Referring now to FIG. 3, there is shown a diagram of an exemplar restaurant application 300 of the system of FIG. 1. Studies have shown that the average bill of restaurant customer can increase by up to 20% if they are able to simply view photos of all the items on the menu. However, many restaurants cannot print photos of all the items on their menu due to the amount of physical space that photos can take up. Furthermore, the average restaurant does not have the resources necessary to develop and maintain a mobile application, nor can they convince enough users to download and install such an application for it to be a worthwhile investment in their business. The present invention can create a visually appealing cloud-based application 322 that will display the menu of a restaurant with a tap of a smartphone 304, 306, 308, 310, 312 over an appropriately placed RFID tag 314, 316, 318, 320. The digital version of the menu displayed on the smartphone 310 will not only contain multiple photos of all the menu items, but it will also allow for comments and ratings of individual items as well as a recommendation engine that will recommend items that the costumer will be interested in based on past history of eating habits collected through the use of WebiTap™ at other locations. WebiTap™'s technologies will not require the customer to download or install any application. Customers of WebiTap™ enabled restaurants will also be able to pay straight from their smartphone. The user's credit card information will be stored in a secure server and charged once the customer places an order at the restaurant, thus alleviating the need for a check or waiting in line at a cash register. An automatic tip calculator will also encourage customers to give a full 10-20 percent tip. An additional analytics tool will provide restaurant owners easy-to-use analytics about the items on their menu, so that they can revise their menu to better fit the demands of their customers. Moreover, WebiTap™ will allow restaurants to send their customers coupons and offers and deploy a rewards program that will help increase customer loyalty.

Restaurants can strategically place WebiTap™ RFID tags 314-320 in places where they want costumers to be able to access the restaurant's WebApp 322. These locations can include, but are not limited to, tags placed on tables 302, tags placed on props on the table, tags placed on physical menus, brochures, carry out packaging and bags, and tags placed on store fronts.

The RFID tags 314-320 can comprise the following information:
A unique code that will be representative of the location of the restaurant and the location of the tag within the restaurant such as table numbers as well as the unique WebApp 322 that is linked to it.
Instructions for the phone to launch the restaurant's WebApp 322 in the smartphone's 310 web browser.

This same information can be encoded into a QR code so that it is accessible by smartphones 304-312 that do not have NFC technology.

Users can tap their smartphone 304-312 on a RFID tag 314-320. Then, the smartphone 310 will read the information on the RFID tag 320, launch the web browser, connect to the WebiTap™ cloud 322 and retrieve the relevant WebApp using the unique code that is encoded on the RFID tag 320.

Once the WebApp 322 has launched in the phone's 310 browser it will look and feel like a native app, and the customer can go ahead and browse through the WebApp 322. In the case of the restaurant the WebApp 322 will serve as an interactive digitalized menu.

The restaurant's WebApp 322 will be organized like a regular menu; however each menu item will have its own page within the WebApp 322. Each menu item page will have a description and several scrollable images of the item. There will also be a section where users can rate and post comments about the food item. Once the customers have found the food item they like, they can simply place the order straight from their phone. The order information will then be sent to WebiTap™'s 322 cloud data processing center.

The WebiTap™ 322 cloud data processing center will then re-route the order information to tablet computers placed in the restaurant's kitchen or order processing center. The WebiTap™ 322 software running on the tablet computer will display the order along with the location in the restaurant that the order was placed from.

If the order was placed using a brochure and was marked for delivery, the WebApp 322 that the order was placed from will obtain a live location of the customer using the GPS receiver on the smartphone and deliver location information as well as order information to the restaurant. The location information obtained from delivery customers can then be used with navigation software to calculate the most efficient route to deliver multiple items.

Once the order is delivered to the customer, the customer's credit/debit card that is linked to their account will be charged automatically and a digital confirmation receipt will be stored in their WebiTap™ account.

WebiTap™ will be collecting user information in order to provide better recommendations and targeted advertising. When an order is placed and the information is sent to WebiTap™'s cloud processing center, back-end software will look for key words associated with the placed order in the item's name and description text. Those key words will then be used to generate a virtual personality profile of the user using machine learning technologies. The generated virtual personality of the user will then be used to recommend new places to visit or new foods to try.

WebiTap™'s restaurant WebApp 322 will also have an integrated rewards program that lets customers trade earned rewards with others on the WebiTap™ network. This process will start with the restaurant defining what and how they want to reward their customers. Once the restaurant owners have decided on their rewards program, they can use WebiTap™'s software to create and activate the rewards program. They can set different parameters for customers to complete such as amount of money spent, number of items purchased, and number of visits and indicated a reward that the customer receives such as a free meal, a free drink or a coupon towards the next purchase. Once the customer has completed the requirements for the reward they can then trade the earned reward with others on the WebiTap™ market place. There will be no set exchange rate for trading rewards, and it will be up to the customer to decide what they want to trade for based on what is more valuable to them at the time of the trade. For example if they have earned a free burger at one restaurant worth about $15 and they need to get a haircut worth $10, they might opt for a trade with someone who has an earned reward for a free haircut at a local barber shop. The actual value of the traded rewards need not be equivalent, as one might be more valuable to the customer at the moment they want to trade. Another example can be if customer has earned a $20 coupon towards their next purchase at a grocery store by spending a set amount of money there, they can choose to trade for a movie ticket earned by somebody else that might be worth less in terms of dollar value but higher in intrinsic value for the customer who wants to watch a movie that evening. WebiTap™ will keep track of the rewards program achievements for each user at every place of business and automatically post all earned or completed rewards to a common social trading marketplace where other WebiTap™ users can search for rewards they need/want and offer trades. Once a user has found a reward they want/need they can offer a trade with one of their earned rewards. Notifications will be sent to the person for the offer that has been made on their earned reward, and if they choose to accept, the rewards will be swapped. As long as the reward has been earned by one customer, and traded with another customer, the reward can be redeemed at the location that issued the reward. This will allow businesses to expand their customer base and encourage their current loyal customers to bring in new customers. Furthermore, since the customers will be able to trade a reward earned from one place for a reward earned at another place, it will make them more loyal to the rewards program and encourage them to complete the reward. This will give the earned rewards some intrinsic value that will encourage customers to stay loyal to their rewards programs in the hopes of being able to trade for rewards at new or rarely visited locations. Note that earned rewards are different from coupons handed out by businesses to everyone. To earn a reward, a customer must participate in the rewards program of the participating business.

Additionally, WebiTap™ can comprise instructions that provide a virtual assistant. The virtual assistant will serve as a notifications terminal. Instead of the notifications being delivered in the normal fashion it will be more personal. The virtual assistant can use terms like “I made sure to confirm your order” instead of “Order confirmed.” The virtual assistant will have access to the data that is collected about each user from their interactions with RFID tags, and use that data to make recommendations in a personal way. The virtual assistant can make recommendations on new dishes to for the user to try and new places to visit based upon the users interest portfolio.

Magazines: Magazine articles can have TagApps™ that contain interactive media that users can access. It can be a video that compliments an article, or a demo of a new product or a concept, sample music, or a slide show. The tags must be strategically placed throughout the magazine to prevent the Smartphone from reading multiple tags at once.

Coupons: Any physical advertisement in a magazine, flier, or poster can carry an RFID tag that will allow the user to save the information from the advertisement. These will be in the form of an AdApp™ as described above.

Video Games and Movies: The packaging can have an RFID tag that launches a TagApp™ that can preview the game, display a video of the game play, display top scores or any other information that the company may want to show a user to persuade the user to buy the game or movie. Digital Versatile Discs (DVD) and BluRay® discs can have a TagApp™ that can preview a trailer of the movie and reviews.

The TagDashboard™ section of the website can comprise organizational tools for the user, such as a calendar system that will sync with other major calendars including Google® Calendar and Microsoft® Outlook. The calendar can automatically display date sensitive TagApps™, that can include expiring offers, event invites, and time sensitive flyers. The TagDashboard™ can also have a friends' stream, displaying all the TagApps™ the user's friends has shared on Facebook®, Twitter®, and other social networking sites.

Although WebiTap™'s infrastructure can only be limited by the creativity of the user, there are many unique and exciting functionality that can be developed using this system as can be appreciated by those with skill in the art with reference to this disclosure. These special features are merely TagApps™ designed with a universal feature in mind, and are more deeply incorporated within the system than other user created TagApps™.

For example: MediApps™ are media oriented TagApps™ that comprise a simple easy to use interface that is designed to provide users with quick access to media that is linked in the RFID tag. Users can instantly view the media associated by the RFID tag simply by swiping their phone over the tag. This provides a revolutionary new way of spreading newly generated media. It can be hard for up-and-coming artists to spread their music beyond their social networks online, however, with this system they can reach out to many others. The artists can upload their music to the WebiTap™'s system and construct a MediApp™ using a pre-designed music player application template that only requires simple information such as song title and artist information and optionally cover artwork. The artists then only have to attach a RFID tag comprising a link to the MediApp™ on distribution media to users. The distribution media can comprise flyers, playbills and posters. The same concept can be applied to photographs or videos. The use of this service can range from simply distributing new music, promoting a product in a simple but media rich manner, or a voice that reads out a flyer.

The WebiTap™ system can generate a powerful interest portfolio that is based on actual interactions with objects and products in the real world. The interest portfolio can be compiled and be used with other websites and services if the user allows sharing in their preferences. For example, users will be able to upload their interest portfolio to services like Netflix or Pulse to get more accurate movie and news recommendations.

The WebiTap™ system further comprises a notification system. Because the applications are never installed on the users Smartphone, the applications can be programmed with executable code to send notifications to the user's WebiTap™ account and the WebiTap™ system can forward the notification to the application on the user's device.

Although the present invention has been discussed in considerable detail with reference to certain preferred embodiments, other embodiments are possible. Therefore, the scope of the appended claims should not be limited to the description of preferred embodiments contained in this disclosure. All references cited herein are incorporated by reference in their entirety.

What is claimed is:

1. A system for creating simple and efficient web based applications and using radio-frequency identification (RFID) tags to link the applications to products, fliers, or any other objects and activated by a near field communications (NFC) enabled mobile device, the system comprising:
a) an application maker;
b) a web host server; and
c) computer instructions for distributing applications and advertisements created by the application maker when a user accesses an RFID tag associated with the application.

2. The system of claim 1, where the application maker comprises templates for creating applications and advertisements.

3. The system of claim 1, where the application maker comprises an application program interface for creating a custom-designed application.

4. The system of claim 1, where the user accesses the RFID tag associated with the application from the group consisting of a tablet, a smart phone and a personal computer.

5. The system of claim 4, where the personal computer can access the applications using a web interface hosted by the web host server.

6. A method for using a system for creating simple and efficient web based applications and using radio-frequency identification (RFID) tags to link the applications to products, fliers, or any other objects and activated by a near field communications (NFC) enabled mobile device, the method comprising the steps of:
a) creating a user account;
b) downloading an application onto a compatible device to login to the user account;
c) synchronizing content selected by the user between the device and the account;
d) scanning an RFID tag associated with an application;
e) downloading instructions operable on the device that can launch a an application associated with the RFID tag; and
f) interacting with the application on the device.

7. The method of claim 6, where the account comprises a comprehensive profile to provide a richer and more personalized experience to the user.

8. The method of claim 6, where interacting with the application on the device also comprises displaying advertisements to the user.

9. The method of claim 6 further comprising the step of storing the application in a storage on the device for later use.

10. The method of claim 6 further comprising the step of distributing the application to other users using social networks.

11. A system for creating simple and efficient web based applications and using radio-frequency identification (RFID) tags to link the applications to products, fliers, or any other objects and activated by a near field communications (NFC) enabled mobile device, the system comprising:
a) a website hub repository for storing applications associated with a user;
b) code operable on the web site comprising instructions for:
1) an update storage for providing updates to a device capable of performing the instructions;
2) an application storage for storing applications created by a user;
3) an interface for creating applications; and
4) a dashboard for tracking applications selected by the user and applications created by the user.

12. The system of claim 11, where the code operable on the website further comprises:
a) computer instructions for analyzing a users' tapping history;
b) computer instructions for constructing a comprehensive, user specific interests portfolio;
c) computer instructions for executing algorithms that can construct a virtual personality of the user based on a frequency of metatags associated with each application stored in the application storage; and
d) computer instructions for distributing advertisements to the user based on the interests portfolio, the virtual personality or both the interest portfolio and the virtual personality.

13. The system of claim 11, where the system further comprises templates for developing applications.

14. The system of claim 11, where the system further comprises an application program interface for developing applications.

15. The system of claim 11, where the RFID tags comprise:
a) a unique code representing a specific location;
b) a unique application operably connected to the unique code; and
c) instructions operable on the device to launch the unique application associated with the unique code.

16. The system of claim 15, where the unique application is launched in a web browser.

17. The system of claim 15, where the unique code is encoded into a QR code.

18. The system of claim 11, further comprising instructions for a notification module.

19. The system of claim 11, where the dashboard module comprises organizational tools for the user.

20. The system of claim 19, where the organizational tools are selected from the group consisting of a calendar, expiring offers, event invites and time sensitive flyers.
